(19) United States
(12) Patent Application Publication
(10) Pub. No.: US 2007/0178848 A1
(43) Pub. Date: Aug. 2, 2007

(54) Generation of wideband frequencies in integrated frequency synthesizer

(76) Inventor: Ju-Young Han, Gwangmyeon-si (KR)

Correspondence Address: LAW OFFICE OF MONICA H CHOI, P O BOX 3424, DUBLIN, OH, 430160204, US

(21) Appl. No.: 11/606,599

(22) Filed: Nov. 30, 2006

(30) Foreign Application Priority Data
Jan. 16, 2006 (KR) 2006-04626

(51) Int. Cl. H04B 1/40

(52) U.S. Cl. 455/76

(57) ABSTRACT

An automatic frequency controller (AFC) is integrated within an one-chip transceiver for controlling both a receiver oscillator and a transmission oscillator. The AFC inputs at least one mode signal indicating one of a reception mode and a transmission mode. The AFC controls the receiver oscillator for the reception mode and controls the transmission oscillator for the transmission mode. Such a one-chip transceiver may be incorporated into compact electronic products.

### BACKGROUND OF THE INVENTION

This application claims priority to Korean Patent Application No. 2006-04626, filed on Jan. 16, 2006 in the Korean Intellectual Property Office, the disclosure of which is incorporated herein in its entirety by reference.

1. Field of the Invention

The present invention relates generally to automatic frequency control (AFC) in a transceiver, and more particularly, to forming an automatic frequency controller for controlling a wideband of frequencies generated from a plurality of oscillators, all integrated on one chip.

2. Description of the Related Art

For wideband data transmission, the frequency range for wireless communication terminals has also been widened. Accordingly, a voltage-controlled oscillator (VCO) included in a wideband communication terminal is desired to operate over a wide frequency range. An AFC circuit controls the VCO to use an appropriate gain curve for operating over a wide frequency range.

FIG. 1A shows a block diagram of a conventional receiving frequency synthesizer 5. FIG. 1B shows a block diagram of a conventional transmitting frequency synthesizer 6.

Referring to FIG. 1A, the conventional receiving frequency synthesizer 5 includes a temperature compensated crystal oscillator (hereinafter, referred to as a “TCXO”) 10, a receiver phase-locked loop (hereinafter, referred to as an “Rx PLL”) 20, a receiver AFC circuit (hereinafter, referred to as an “Rx AFC circuit”) 40, and a receiver VCO (hereinafter, referred to as an “Rx VCO”) 30.

The TCXO 10 generates a reference frequency signal. The Rx PLL 20 compares the frequency of a first signal FR with the frequency of a second signal FV to generate a receiver control voltage RVt. The receiver control signal RVt is transmitted to the Rx VCO 30 for synchronizing the frequencies of the first and second signals FR and FV.

The Rx AFC circuit 40 compares the frequencies of the first and second signals FR and FV to generate an Rx code used by the Rx VCO for selecting one from a plurality of gain curves. The Rx VCO 30 generates an oscillation signal Rf with a frequency determined by the selected gain curve and the receiver control voltage RVt.

The first signal FR is a frequency-divided signal of the reference frequency signal from the TCXO 10. The second signal FV is a frequency-divided signal of the oscillation signal Rf from the Rx VCO 30.

Referring to FIG. 1B, the conventional transmitting frequency synthesizer 6 includes a TCXO 15, a transmitter PLL (hereinafter, referred to as a “Tx PLL”) 25, a transmitter AFC circuit (hereinafter, referred to as a “Tx AFC circuit”) 45, and a transmitter VCO (hereinafter, referred to as a “Tx VCO”) 35.

The TCXO 15 oscillates a reference frequency signal. The Tx PLL 25 compares the frequency of a first signal FRR with the frequency of a second signal FVV to generate a transmitter control voltage TVt for synchronizing the frequencies of the first and second signals FRR and FVV.

The Tx AFC circuit 45 compares the frequencies of the first and second signals FRR and FVV to generate a Tx code used by the Tx VCO 35 for selecting one from a plurality of gain curves. The Tx VCO 35 generates an oscillation signal Tf with a frequency determined by such a selected gain curve and the transmitter control voltage TVt.

Here, the first signal FRR is a frequency-divided signal of the reference frequency signal from the TCXO 15. The second signal FVV is a frequency-divided signal of the oscillation signal Tf from the Tx VCO 35.

In the above conventional technology, the transmitting frequency synthesizer 6 and the receiving frequency synthesizer 5 are implemented separately. For example, the AFC circuit 40 for the Rx VCO 30 and the AFC circuit 45 for the Tx VCO 35 are implemented separately.

Recently, a receiver and a transmitter are implemented on one chip according to the demand for compact and slim products. Thus, an Rx VCO and a Tx VCO are increasingly implemented on one chip. Accordingly, an Rx AFC circuit and a Tx AFC circuit are desired to be integrated on one chip with reduced size of the chip and with simple circuitry.

### SUMMARY OF THE INVENTION

Accordingly, a one-chip transceiver according to an embodiment of the present invention includes an AFC (automatic frequency controller) for controlling both an Rx VCO and a Tx VCO.

Such an automatic frequency controller includes a start controller, a frequency detector, and a data code block. The start controller indicates one of a reception mode and a transmission mode of operation. The frequency detector compares a reference signal with a receiver signal in a reception mode, and compares the reference signal with a transmitter signal in a transmission mode. The data code block determines a receiver code in the reception mode, and determines a transmitter code in the transmission mode, depending on the comparison from the frequency detector.

The automatic frequency controller may be advantageously formed in an integrated frequency synthesizer having a receiver oscillator and a transmitter oscillator. The receiver oscillator generates the receiver signal according to a receiver gain curve determined by the receiver code. The transmitter oscillator generates the transmitter signal according to a transmitter gain curve determined by the transmitter code.

In another embodiment of the present invention, the transmitter oscillator, the receiver oscillator, the start controller, the frequency detector, and the data code block are formed on one chip. In another embodiment of the present invention, the integrated frequency synthesizer also includes a reference oscillator, such as a temperature compensated crystal oscillator for example, that generates the reference signal.

In a further embodiment of the present invention, the start controller includes circuitry for entering a stand-by mode for a current reception or transmission mode until a prior reception or transmission mode is terminated. The prior reception or transmission mode is terminated when a respective gain curve is determined for the prior reception or transmission mode.

An integrated frequency synthesizer in another embodiment of the present invention further includes a first reference frequency divider, a receiver frequency divider, a receiver phase-locked loop (PLL), a second reference frequency divider, a transmitter frequency divider, and a transmitter phase-locked loop (PLL).

The first reference frequency divider generates a first divided reference signal by frequency-division of the reference signal. The receiver frequency divider generates a divided receiver signal by frequency-division of the receiver signal. The receiver PLL compares the first divided reference signal with the divided receiver signal to generate a first control signal that determines a frequency of the receiver signal in accordance with the receiver gain curve.

The second reference frequency divider generates a second divided reference signal by frequency-division of the reference signal. The transmitter frequency divider generates a divided transmitter signal by frequency-division of the transmitter signal. The transmitter PLL compares the second divided reference signal with the divided transmitter signal to generate a second control signal that determines a frequency of the transmitter signal in accordance with the transmitter gain curve.

In addition, the frequency detector compares the first divided reference signal with the divided receiver signal to generate the receiver code sent to the receiver oscillator for determining the receiver gain curve in the reception mode. Similarly, the frequency detector compares the second divided reference signal with the divided transmitter signal to generate the transmitter code sent to the transmitter oscillator for determining the transmitter gain curve in the transmission mode.

In this manner, the automatic frequency controller is integrated within the transceiver for controlling both the receiver oscillator and the transmitter oscillator. Thus, the transceiver may be formed as one-chip for incorporation into compact and slim electronic products.

### BRIEF DESCRIPTION OF THE DRAWINGS

The above and other features and advantages of the present invention will become more apparent when described in detailed exemplary embodiments thereof with reference to the attached drawings in which:

FIG. 1A is a block diagram of a conventional receiving frequency synthesizer, and FIG. 1B is a block diagram of a conventional transmitting frequency synthesizer;

FIG. 2 is a block diagram of a wideband wireless communication system according to an embodiment of the present invention;

FIG. 3 is a block diagram of an integrated frequency synthesizer within the communication system of FIG. 2, according to an embodiment of the present invention;

FIG. 4 is a block diagram of an automatic frequency controller (AFC) in the integrated frequency synthesizer of FIG. 3, according to an embodiment of the present invention;

FIG. 5 shows example linear gain curves of a receiver voltage-controlled oscillator (Rx VCO) and a transmitter (Tx) VCO for various example codes, in an embodiment of the present invention;

FIGS. 6A and 6B illustrate a flowchart during operation of the automatic frequency controller of FIG. 4, according to an embodiment of the present invention;

FIG. 7 is a timing diagram of signals generated during operation of the automatic frequency controller of FIG. 4, according to an embodiment of the present invention; and

FIG. 8 is a diagram of example circuitry within the automatic frequency controller of FIG. 4 for generating the signals of FIG. 7, according to an embodiment of the present invention.

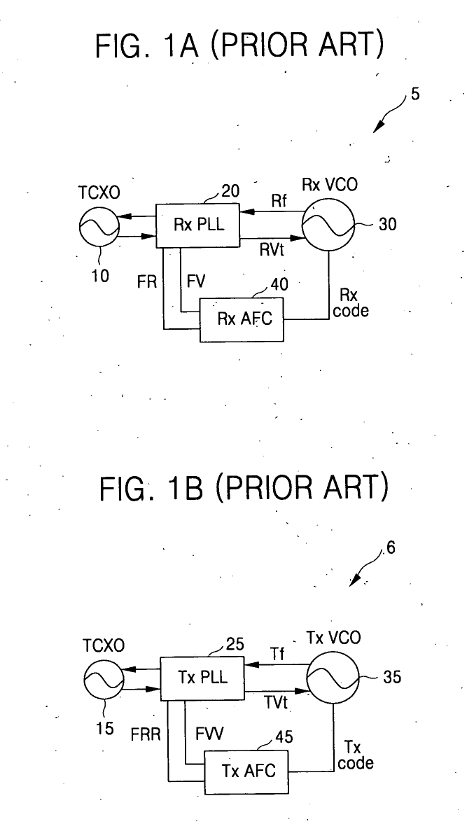

The figures referred to herein are drawn for clarity of illustration and are not necessarily drawn to scale. Elements having the same reference number in FIGS. 1A, 1B, 2, 3, 4, 5, 6, 7, and 8 refer to elements having similar structure and/or function.

### DETAILED DESCRIPTION OF THE INVENTION

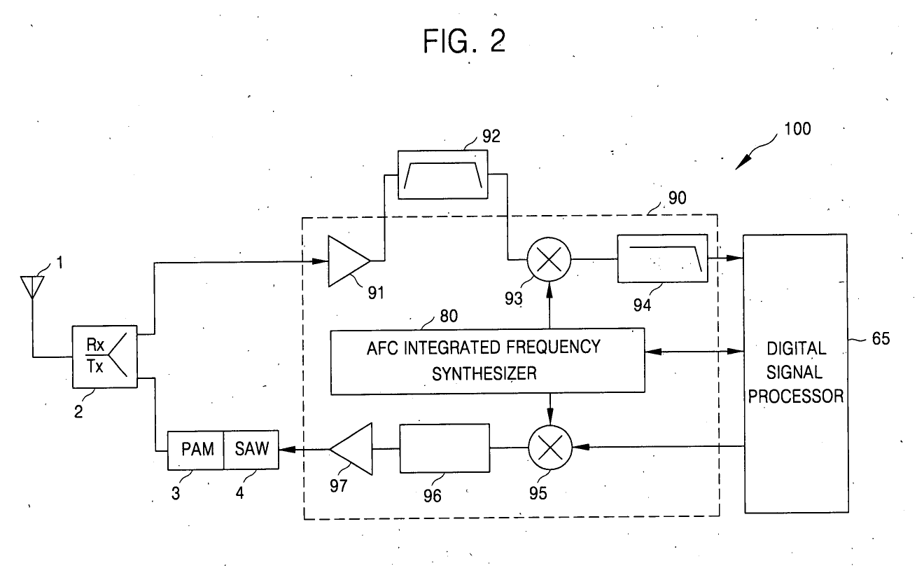

FIG. 2 is a block diagram of a wideband wireless communication system 100 according to an embodiment of the present invention. Referring to FIG. 2, the wideband wireless communication system 100 includes an antenna 1, a duplexer 2, a power amplifier module (PAM) 3, a surface acoustic wave (SAW) filter 4, a one-chip transceiver 90, and a digital signal processor 65.

The one-chip transceiver 90 includes a receiver (Rx) low noise amplifier (LNA) 91, an Rx mixer 93, an Rx low pass filter (LPF) 94, a transmitter (Tx) mixer 95, a first Tx filter 96, and a Tx LNA 97. An Rx band pass filter (BPF) 92 may be implemented outside the one-chip transceiver 90, as illustrated in FIG. 2 or may be implemented inside the one-chip transceiver 90. In addition, the one-chip transceiver 90 includes an AFC (automatic frequency control) integrated frequency synthesizer 80.

The antenna 1 is used for both transmission and reception, and receives a radio frequency (RF) receiving signal and transmits an RF transmitting signal. The duplexer 2 is used when a transmitting signal and a receiving signal are transmitted and received through the one antenna 1.

A receiving signal received through the antenna 1 and the duplexer 2 has noise and a relatively low power level from attenuation and noise. Accordingly, the Rx LNA 91 amplifies the power level of the receiving signal and minimizes noise. The Rx BPF 92 removes unwanted frequency components from the receiving signal amplified by the Rx LNA 91.

The Rx mixer 93 mixes the band pass filtered receiving signal with a receiver frequency oscillation signal generated by the AFC integrated frequency synthesizer 80. Thus, the Rx mixer 93 generates the receiving signal down-converted to a low-band frequency. The Rx LPF 94 performs low pass filtering on the receiving signal output from the Rx mixer 93 and outputs a resulting signal to the digital signal processor 65.

The digital signal processor 65 performs digital signal processes such as demodulation, deinterleaving, and decoding on the signal output from the Rx LPF 94, thereby recovering original data. In addition, the digital signal processor 65 outputs a transmitting signal and controls the AFC integrated frequency synthesizer 80.

The Tx mixer 95 receives a transmitting signal from the digital signal processor 65. The Tx mixer 95 mixes the low-frequency transmitting signal with a transmitter frequency oscillation signal generated by the AFC integrated frequency synthesizer 80, thereby outputting the transmitting signal up-converted to a high frequency.

The first Tx filter 96 is a high pass filter and passes only a high frequency component. The Tx LNA 97 minimizes low-band noise of the high-frequency transmitting signal and then outputs the high-frequency transmitting signal.

The PAM 3 and the SAW filter 4 pass and amplify only particular frequency components to be transmitted. An output signal of the PAM 3 is transmitted via the duplexer 2 and the antenna 1.

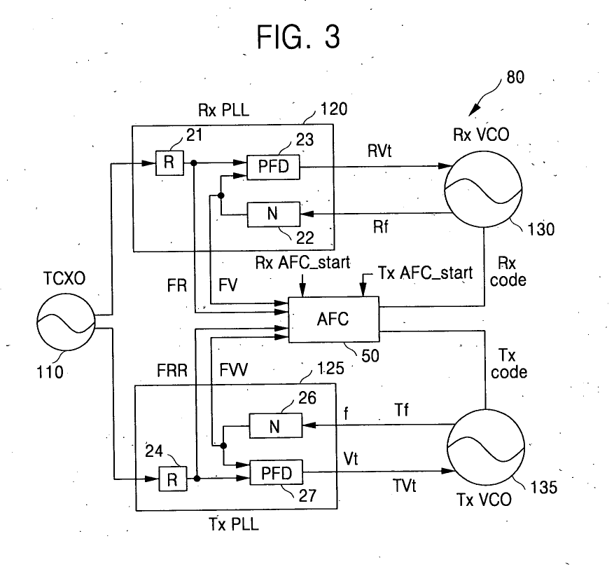

FIG. 3 shows a block diagram of the AFC integrated frequency synthesizer 80 according to an embodiment of the present invention. Referring to FIG. 3, the AFC integrated frequency synthesizer 80 has integrated therein a transmitting frequency synthesizer and a receiving frequency synthesizer. The AFC integrated frequency synthesizer 80 includes a temperature compensated crystal oscillator (hereinafter, referred to as a “TCXO”) 110 as an example of a reference oscillator for generating a reference frequency oscillation signal.

The AFC integrated frequency synthesizer 80 also includes an Rx phase-locked loop (PLL) 120, a Tx PLL 125, an Rx voltage-controlled oscillator (VCO) 130, a Tx VCO 135, and an AFC (automatic frequency controller) 50. The Rx PLL 120 includes an Rx R frequency divider 21, an Rx N frequency divider 22, and an Rx phase-frequency detector (PFD) 23. The Tx PLL 125 includes a Tx R frequency divider 24, a Tx N frequency divider 26, and a Tx PFD 27.

The TCXO 110 is an oscillator that is designed for minimum influence from external temperature for generating the reference frequency oscillation signal with a stable reference frequency. The Rx VCO 130 selects one from a plurality of gain curves according to an Rx code generated by the AFC 50. The Rx VCO 130 generates a receiver frequency oscillation signal Rf having a frequency determined by such a selected gain curve and a receiver control voltage RVt from the Rx PLL 120.

The Tx VCO 135 selects one from a plurality of gain curves according to a Tx code generated by the AFC 50. The Tx VCO 135 also generates a transmitter frequency oscillation signal Tf having a frequency determined by such a selected gain curve and a transmitter control voltage TVt from the Tx PLL 125.

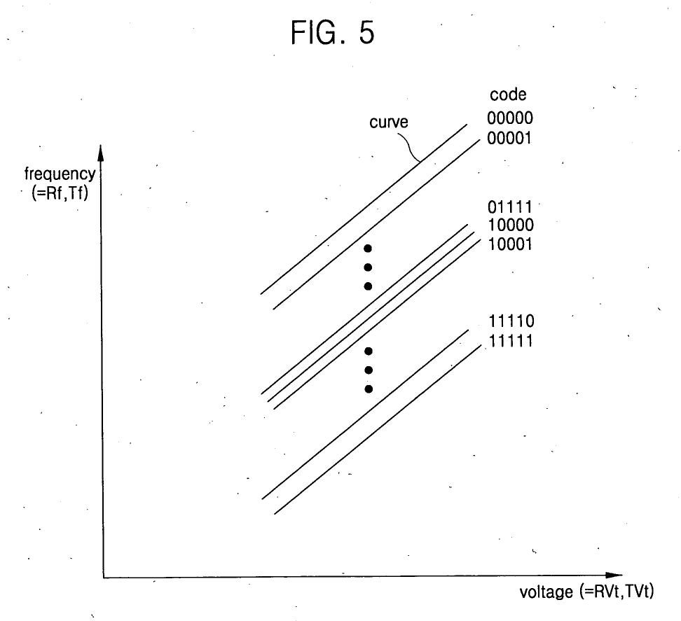

FIG. 5 illustrates example linear gain curves for the Rx VCO 130 and the Tx VCO 135 with respect to example codes. Referring to FIG. 5, the Rx VCO 130 and the Tx VCO 135 have wideband operating frequency range by operating with a unique gain curve for each code.

Each gain curve indicates the frequency of each respective oscillation signal generated by each of the Rx VCO 130 and the Tx VCO 135 with respect to the transmitter control voltage TVf and the receiver control voltage RVf, respectively. In the example of FIG. 5, such a frequency of the oscillation signal is proportional to the transmitter control voltage TVf or the receiver control voltage RVf. The AFC 50 generates the Rx code and the Tx code for determining the selected gain curve within each of the Rx VCO 130 and the Tx VCO 135, respectively.

Referring to back to FIG. 3, the Rx R frequency divider 21 receives the reference frequency oscillation signal and performs frequency-division by a factor of R, thereby generating a first frequency-divided reference signal FR. The Rx N frequency divider 22 receives the receiver frequency oscillation signal Rf and performs frequency-division by a factor of N, thereby generating a frequency-divided receiver signal FV. Here, N and R may be integers greater than 1 but do not need to be integers.

The Rx PFD 23 receives the first frequency-divided reference signal FR and the frequency-divided receiver signal FV for comparing the frequencies of such signals FR and FV. The Rx PFD 23 generates the receiver control voltage RVt based on the result of such a comparison. In other words, the Rx PFD 23 adjusts the receiver control voltage RVt so that the first frequency-divided reference signal FR and the frequency-divided receiver signal FV are synchronized with each other.

The Tx R frequency divider 24 receives the reference frequency oscillation signal and performs frequency-division by a factor R, thereby generating a second frequency-divided reference signal FRR. The Tx N divider 26 receives the transmitter frequency oscillation signal Tf and performs frequency division by a factor of N, thereby outputting a frequency-divided transmitter signal FVV.

The Tx PFD 27 receives the second frequency-divided reference signal FRR and the frequency-divided transmitter signal FVV for comparing the frequencies of such signals FRR and FVV. The Tx PFD 27 generates the transmitter control voltage TVt based on the result of such a comparison. In other words, the Tx PFD 27 adjusts the transmitter control voltage TVt so that the second frequency-divided reference signal FRR and the frequency-divided transmitter signal FVV are synchronized with each other.

The AFC 50 generates the Rx code and the Tx code used by the Rx VCO 130 and the Tx VCO 135, respectively, each for selecting a respective gain curve. In detail, the AFC 50 is integrated for both transmission and reception and generates the Tx code in a transmission mode and generates the Rx code in a reception mode.

The AFC 50 receives a reception start signal Rx AFC_start and a transmission start signal Tx AFC_start (that are mode indication signals). The reception start signal Rx AFC_start may be generated by the Rx PLL 120, and the transmission start signal Tx AFC_start may be generated by the Tx PLL 125.

For example, for changing the frequency of the receiver frequency oscillation signal Rf when an RF receiving signal is newly received or a channel is changed, the Rx PLL 120 activates the reception start signal Rx AFC_start. Alternatively, for changing the frequency of the transmitter frequency oscillation signal Tf when an RF transmitting signal is newly received or a channel is changed, the Tx PLL 125 activates the transmission start signal Tx AFC_start.

When the reception start signal Rx AFC_start is activated, the AFC 50 may enter the reception mode for comparing the first frequency-divided reference signal with the frequency-divided receiver signal FV to generate the Rx code based on the result of the comparison. When the transmission start signal Tx AFC_start is activated, the AFC 50 may enter the transmission mode for comparing the second frequency-divided reference signal FRR with the frequency-divided transmitter signal FVV to generate the Tx code based on the result of the comparison.

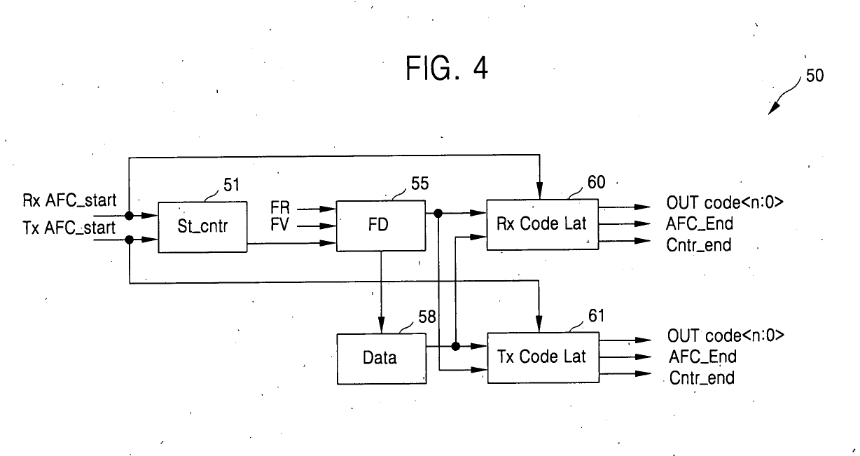

FIG. 4 is a block diagram of the AFC 50 according to an embodiment of the present invention. Referring to FIG. 4, the AFC 50 includes a start controller (labeled as “St_cntr” in FIG. 4) 51, a frequency detector (labeled as “FD” in FIG. 4) 55, a data code block (labeled as “Data” in FIG. 4) 58, a Rx code latch circuit (labeled as “Rx code Lat” in FIG. 4) 60, and a Tx code latch circuit (labeled as “Tx code Lat” in FIG. 4) 61.

The start controller 51 responds to any of the reception start signal Rx AFC_start and the transmission start signal Tx AFC_start being activated by enabling the FD 55 after being on standby for a predetermined period of time. The Rx code latch circuit 60 is enabled in response to the reception start signal Rx AFC_start being activated, and the Tx code latch circuit 61 is enabled in response to the transmission start signal Tx AFC_start being activated.

In the reception mode, the FD 55 receives and compares the first frequency-divided reference signal FR and the frequency-divided receiver signal FV. In the transmission mode, the FD 55 receives and compares the second frequency-divided reference signal FRR and the frequency-divided transmitter signal FVV. The operation of the FD 55 in the transmission mode is substantially similar as that in the reception mode. Thus, for clarity of description, the operation of the FD 55 in the reception mode is now representatively described.

The FD 55 generates a current Rx code to the Rx code latch circuit 60 and maintains the Rx code when a frequency difference (or a cycle difference) between the first frequency-divided reference signal FR and the frequency-divided receiver signal FV is within a predetermined range. When the frequency difference (or the cycle difference) between the first frequency-divided reference signal FR and the frequency-divided receiver signal FV is not within the predetermined range, the data code block 58 adjusts the Rx code.

The data code block 58 adjusts the Rx code for determining an Rx code which will result in the frequency difference between the first frequency-divided reference signal FR and the frequency-divided receiver signal FV being within the predetermined range. When such a Rx code is iteratively determined such that the frequency difference between the first frequency-divided reference signal FR and the frequency-divided receiver signal FV is within the predetermined range, the data code block 58 outputs such a Rx code to the Rx code latch circuit 60.

The Rx code latch circuit 60 latches such an Rx code that is output as code value OUT code<n:0>. In addition, a signal AFC_End is activated for indicating a status of operation of the AFC 50 to the Rx VCO 130.

The AFC 50 operates similarly in the transmission mode with the Tx code latch circuit 61 latching the Tx code output from the FD 55 or the data code block 58. The Tx code latch circuit 61 outputs an iteratively determined Tx code as code value OUT code<n:0> and also generates a signal AFC_End indicating a status of operation of the AFC 50 to the Tx VCO 135.

For example, while the AFC 50 is actively operating to determine an Rx or Tx code in one of the reception or transmission modes, the AFC_End signal is at a logic low level. When such a code has been determined, the AFC_End signal is set to a logic high level.

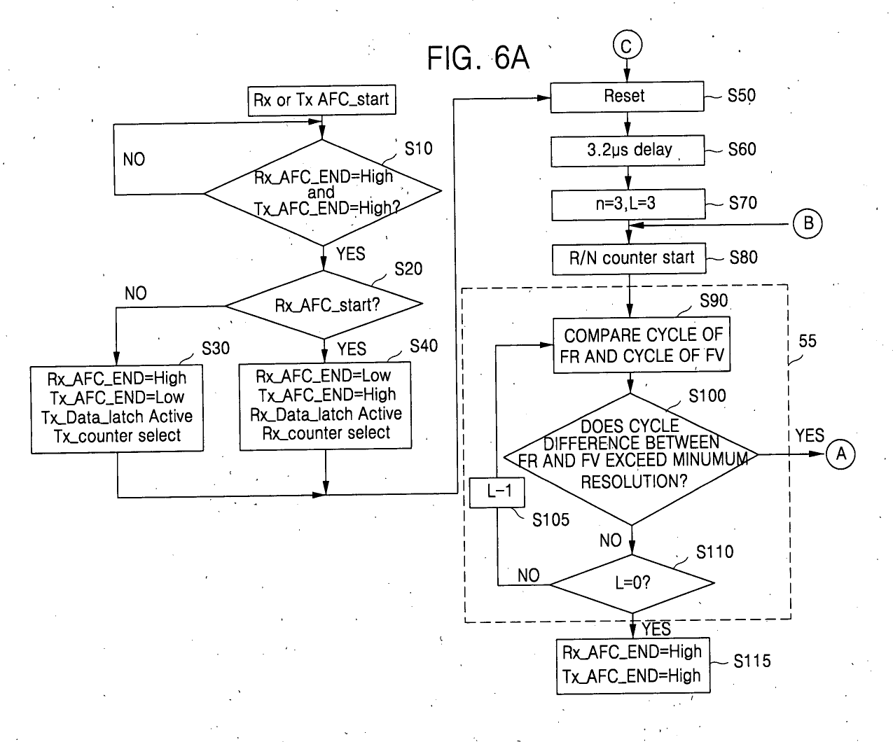

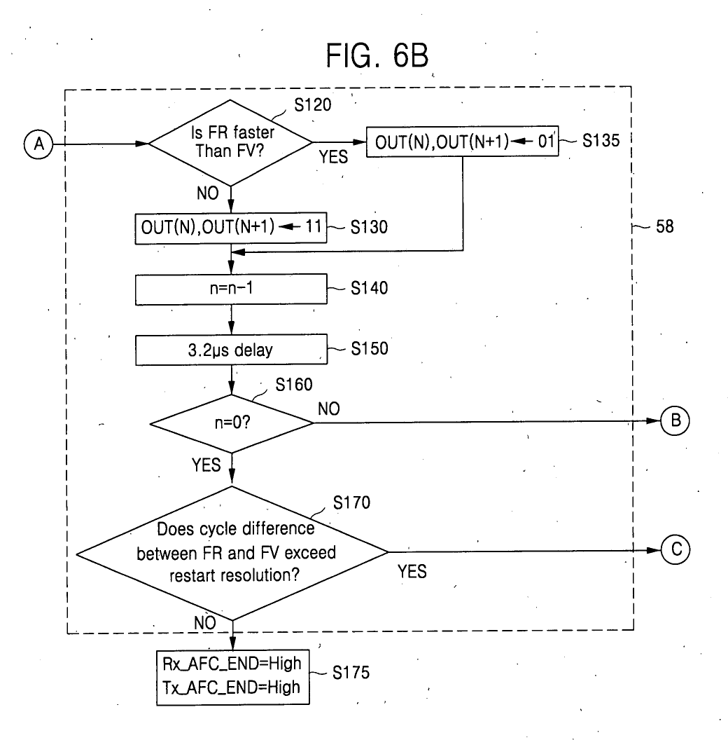

FIGS. 6A and 6B illustrate a flowchart of an automatic frequency control method according to an embodiment of the present invention. The flow-chart of FIGS. 6A and 6B shows steps during operation of the AFC 50 of FIG. 4.

Referring to FIGS. 4, 6A, and 6B, when a reception start signal Rx AFC_start or a transmission start signal Tx AFC_start is activated, the St_cntr 51 determines whether the AFC 50 is already operating for a prior reception or transmission mode (i.e., whether Rx_AFC_END=High and Tx_AFC_END=High in step S10 of FIG. 6A).

When the prior reception or transmission mode has not yet terminated because the corresponding Rx or Tx code is still being determined, one of the Rx_AFC_END and Tx_AFC_END signals is at the logic low level. In that case, the St_cntr 51 enters a standby mode for the activated one of the reception start signal Rx AFC_start or the transmission start signal Tx AFC_start.

When the prior reception or transmission mode is terminated because the corresponding Rx or Tx code has been determined, the transmission end signal Tx_AFC_END and the reception end signal Rx_AFC_END are both at the logic high level. In that case, the St_cntr 51 enters a current transmission or reception mode depending on the activated one of the reception start signal Rx AFC_start and the transmission start signal Tx AFC_start.

When the reception start signal Rx AFC_start is activated (in step S20 of FIG. 6A), an initial setting is performed for entering the reception mode (in step S40 of FIG. 6A). In that case, the reception end signal Rx_AFC_END is set to the logic low level (i.e., Rx_AFC_END=Low in FIG. 6A), and the transmission end signal Tx_AFC_END is set to the logic high level (i.e., Tx_AFC_END=High in FIG. 6A). In addition for the reception mode, the Rx data latch circuit 60 is activated (i.e., Rx_Data_latch Active in FIG. 6A), and the frequency dividers 21 and 22 of the Rx PLL 120 are selected (i.e., Rx_counter select in FIG. 6A).

On the other hand, if the transmission start signal Tx AFC_start is activated instead (in step S20 of FIG. 6A), an initial setting is performed for the transmission mode in the similar manner as is performed for the reception mode (in step S30 of FIG. 6A). Thus, Tx_AFC_END is set to the logic low state, and Rx_AFC_END is set to the logic high state. Additionally for the transmission mode, the Tx data latch circuit 61 is activated (i.e., Tx_Data_latch Active in FIG. 6A), and the frequency dividers 24 and 26 of the Tx PLL 125 are selected (i.e., Tx_counter select in FIG. 6A).

For an example description of the present invention, assume that the reception start signal Rx AFC_start is activated for the reception mode. After the initial setting in step S40, the FD 55 and the data code block 58 in the AFC 50 are reset (in step S50 of FIG. 6A), and a predetermined period of time delay (such as 3.2 micro-second) is passed before operation of the Rx VCO (in step S60 in FIG. 6A).

Furthermore, an Rx code change count “n” and a frequency-division change count L are each initialized to a respective predetermined value, e.g., 3 (in step S70 of FIG. 6A). The Rx code change count “n” and the frequency-division change count L may be set by a user in one embodiment of the present invention.

After such initiation and resetting, the Rx R frequency divider 21 and the Rx N frequency divider 22 are started (in step S80 of FIG. 6A). Then, the Rx R frequency divider 21 and the Rx N frequency divider 22 each perform frequency division to generate the first frequency-divided reference signal FR and the frequency-divided receiver signal FV, as described above. The FD 55 compares such signals FR and FV (in step S90 of FIG. 6A) by for example determining whether a cycle difference between such signals FR and FV exceeds a minimum resolution (step S100 in FIG. 6A). Such a minimum resolution may be set by the user in an embodiment of the present invention.

If the cycle difference between such signals FR and FV exceeds the minimum resolution, such signals are transmitted to the data code block 58. Alternatively, if the cycle difference between such signals FR and FV do not exceed the minimum resolution, a value of the frequency-division change count L is changed (steps S110 and S105 of FIG. 6A) to more precisely compare the cycle difference between such signals FR and FV back in steps S90 and S100.

In other words, a respective division factor for each of the first frequency-divided reference signal FR and the frequency-divided receiver signal FV is increased such that a cycle difference between such signals FR and FV is more finely detected. For this operation, at least one additional frequency divider for such further frequency division of the signals FR and FV may be included in the FD 55. When the frequency-division change count L is 0 in step S110, the operation of the AFC for the reception mode ends, and the reception end signal Rx_AFC_END is set to the logic high level (in step S115 of FIG. 6A).

Alternatively, if the cycle difference between the signals FR and FV exceeds the minimum resolution (in step S100 of FIG. 6A), the flow-chart proceeds to FIG. 6B with the signals FR and FV being output to the data code block 58. The data code block 58 determines whether the first frequency-divided reference signal FR is faster than the frequency-divided receiver signal FV (step S120 of FIG. 6B).

If the signal FR is faster than the signal FV, code bits OUT(N) and OUT(N+1) (with N=n) of the Rx code are changed to “01⇄ (in step S135 of FIG. 6B). For example, when the Rx code is “10000” and is changed once, the changed Rx code is “01000”. Alternatively, if the signal FV is faster than the signal FR, the code bits QUT(N) and OUT(N+1) in the Rx code are changed to “11” (in step S130 of FIG. 6B). For example, when the Rx code is “10000” and is changed once, the changed Rx code is “11000”.

After any change of the Rx code in steps S130 or S135, the Rx code change count “n” is reduced by 1 (in step S140 of FIG. 6B). Another predetermined period of time (such as 3.2 micro-seconds for example) is delayed for another initiation of the Rx VCO (in step S150 of FIG. 6B). The data code block 58 then determines whether the Rx code change count “n” is 0 (step S160 of FIG. 6B). If the Rx code change count “n” is not 0, the flow-chart of FIG. 6B loops back to step S80 of FIG. 6A, and subsequent steps of FIGS. 6A and/or 6B are repeated until the Rx code change count “n” is 0.

When the Rx code change count “n” is 0, data code block 58 determines whether the cycle difference between the signals FR and FV exceeds a restart resolution (in step S170 of FIG. 6B). If the cycle difference between the signals FR and FV does not exceed the restart resolution, a current Rx code is maintained and the receiver mode is terminated in the AFC 50 with the reception end signal Rx_AFC_END being set to the logic high level (in step S175 of FIG. 6B). Alternatively, if the cycle difference between the signals FR and FV exceeds the restart resolution, the flow-chart of, FIG. 6B loops back to step S50 of FIG. 6A, and subsequent steps of FIGS. 6A and/or 6B are repeated.

The flow-chart of FIGS. 6A and 6B have been described for the reception mode. However, the steps for the transmission mode would be similar as described for the reception mode, as would be apparent to one of ordinary skill in the art from the description of the reception mode herein.

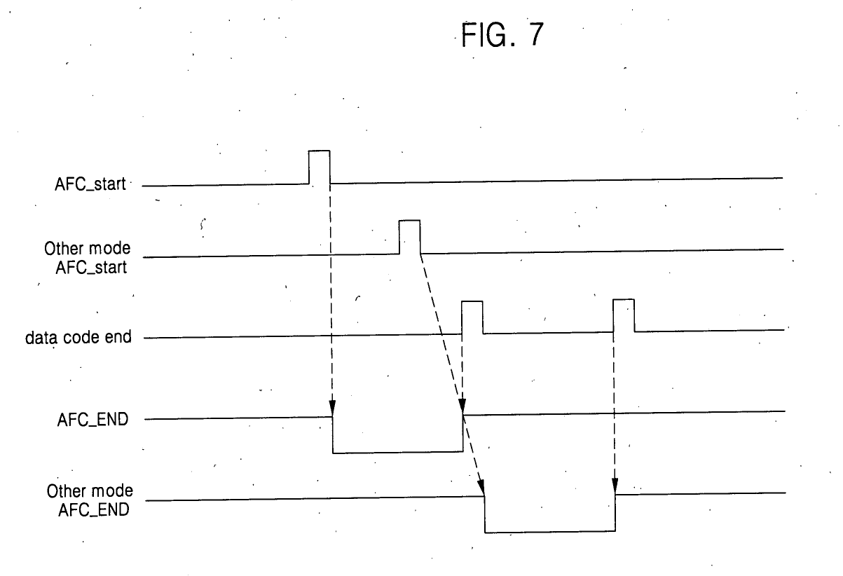

FIG. 7 shows a timing diagram of signals generated during operation of the AFC 50 in an embodiment of the present invention. After an activation pulse of an AFC_start signal (such as one of Rx_AFC_start and Tx_AFC_start signals that are mode indication signals), an AFC_END signal corresponding to the mode of such an activated AFC_start signal is set to the logic low state for activation of that current mode.

When a data code corresponding to the current mode has been determined, an activated pulse of the data code end signal is generated. As a result, the AFC_END signal is set to the logic high level in response to the activated data code end signal, as illustrated in FIG. 7.

If an AFC_start signal for the other mode (i.e., the other one of the Rx_AFC_start and Tx_AFC_start signals) is activated for a next mode before the prior AFC_END signal is set to the logic high level, a stand-by mode is entered until the prior AFC_END signal transits to the logic high level for termination of the prior mode. When the AFC_END signal transits to the logic high level for such termination, the next mode corresponding to the other mode AFC_start signal is activated when the other mode AFC_END signal is set to the logic low level as illustrated in FIG. 7.

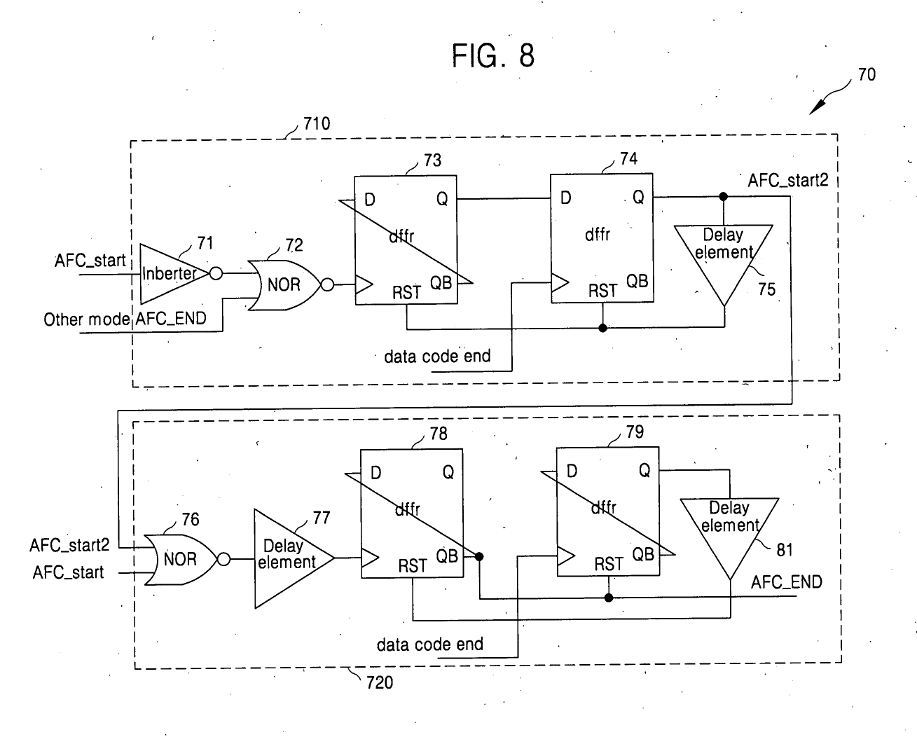

FIG. 8 is a diagram of an example logic circuit 70 within the automatic frequency controller of FIG. 4 for generating the signals of FIG. 7, according to an embodiment of the present invention. The logic circuit 70 includes a standby circuit 710 and an AFC end signal generation circuit 720. The standby circuit 710 includes an inverter 71, a first logic circuit 72, a first flip-flop 73, a second flip-flop 74, and a first delay element 75. The AFC end signal generation circuit 720 includes a second logic circuit 76, a third flip-flop 78, a fourth flip-flop 79, a second delay element 77, and a third delay element 81.

When an AFC_start signal corresponding to one mode (such as the reception mode for example) is activated to the logic high level while the other mode (such as the transmission mode in this example) is already activated with the other mode AFC_END signal set at the logic low level, the standby circuit 710 enters a standby mode until the AFC operation for the transmission mode is terminated. At that point, the AFC_start2 signal is activated when the other mode AFC_END signal transits to the logic high level.

In particular in FIG. 8, assume that the AFC_start signal transits to the logic high level while the other mode AFC_END signal is at the logic low level. In this case, an output signal of the first logic circuit 72 which is input to a clock terminal of the first flip-flop 73 is at the logic-high level. Here, the first and second flip-flops 73 and 74 have a reset state in which an output signal Q is at a logic low level of “0” and an inverted output signal QB is at a logic high level of “1”.

In such a reset state, when a signal input to the clock terminal of the first flip-flop 73 is at the logic high level, the output signal Q of the first flip-flop 73 transits to the logic high level. The second flip-flop 74 generates the output signal Q at the logic high level when a data code end signal transits to the logic high level.

Such a transition of the data code end signal indicates that the other mode is terminated, and the AFC_start2 signal transits to the logic high level. The first delay element 75 delays the AFC_start2 signal by a predetermined period of time so that the first and second flip-flops 73 and 74 are reset the predetermined period of time after the AFC_start2 signal transits to the logic high level.

The AFC end signal generation circuit 720 generates the AFC_END signal in response to the AFC_start signal. In detail, for setting the AFC 50 in a standby mode, the AFC end signal generation circuit 720 generates the AFC_END signal with the logic low level immediately in response to the activated AFC_start signal. Alternatively when the AFC_END signal is set to the logic low level, the mode corresponding to the activated AFC_start signal is entered.

For example, when an Rx_AFC_END signal is set to the logic low level, the reception mode is entered. When a Tx_AFC_END signal is set to the logic low level, the transmission mode is entered. The AFC end signal generation circuit 720 generates the AFC_END signal with the logic low level in response to the activated AFC_start2 signal.

In detail, the third and fourth flip-flops 78 and 79 have a reset state in which an output signal Q is at the logic low level of “0” and an inverted output signal QB is at the logic high level of “1”. While a prior mode is activated, the third and fourth flip-flops 78 and 79 are in the reset state. In such reset state, the inverted output signal QB of the third flip-flop 78, i.e., the AFC_END signal is at the logic high level.

On the other hand, assume that no prior mode is activated and that the AFC_start signal is activated with a logic high pulse, as illustrated in FIG. 7. In that case, a signal input to a clock terminal of the third flip-flop 78 transits from the logic low level to the logic high level so that the output signal Q of the third flip-flop 78 transits to the logic high level and the inverted output signal QB thereof transits to the logic low level.

Accordingly, the AFC_END signal transits to the logic low level. When a prior mode terminates after the data code end signal transits to the high level, the output signal Q of the fourth flip-flop 79 transits to the logic high level and the inverted output signal QB thereof transits to the logic low level. The third delay element 81 delays the output signal Q of the fourth flip-flop 79 by a predetermined period of time so that the third and fourth flip-flops 78 and 79 are reset the predetermined period of time after the output signal Q of the fourth flip-flop 79 transits to the logic high level.

However, when a prior mode is in activation, the third and fourth flip-flops 78 and 79 are in the reset state even if the AFC_start signal is activated. When the prior mode is terminated, the third flip-flop 78 generates the output signal Q at the logic high level and the inverted output signal QB at the logic low level in response to the AFC_start2 signal. Accordingly, the AFC_END signal is generated with the logic low level.

In this manner, the automatic frequency controller 50 is integrated within the one-chip transceiver 90 for controlling both the receiver oscillator 130 in the reception mode and the transmission oscillator 135 in the transmission mode. All components of the transceiver 90 are fabricated as a single integrated circuit die in one embodiment of the present invention. Such a transceiver may be incorporated into compact and slim electronic products.

While the present invention has been particularly shown and described with reference to exemplary embodiments thereof, it will be understood by those of ordinary skill in the art that various changes in form and details may be made therein without departing from the spirit and scope of the present invention as defined by the following claims.

Thus, the foregoing is by way of example only and is not intended to be limiting. For example, any numbers or number of elements described and illustrated herein is by way of example only. The present invention is limited only as defined in the following claims and equivalents thereof.

What is claimed is:

1. A method of generating any of a receiver signal and a transmitter signal, comprising:
receiving at least one mode signal indicating one of a reception mode and a transmission mode;
comparing a reference signal with the receiver signal to determine a receiver gain curve used for generating the receiver signal in the reception mode; and
comparing the reference signal with the transmitter signal to determine a transmitter gain curve used for generating the transmitter signal in the transmission mode.

2. The method of claim 1, further comprising:
generating the reference signal at a reference oscillator;
generating the receiver signal at a receiver oscillator having the receiver gain curve; and
generating the transmitter signal at a transmitter oscillator having the transmitter gain curve.

3. The method of claim 2, wherein the reference oscillator is a temperature-compensated crystal oscillator.

4. The method of claim 2, further comprising:
forming, on one chip, the transmitter oscillator, the receiver oscillator, and an automatic frequency controller that performs the steps of the receiving and the comparings.

5. The method of claim 2, further comprising in the reception mode:
generating a divided reference signal by frequency-division of the reference signal;
generating a divided receiver signal by frequency-division of the receiver signal; and
comparing the divided reference signal with the divided receiver signal to generate a receiver code sent to the receiver oscillator for determining the receiver gain curve.

6. The method of claim 5, further comprising in the reception mode:
comparing the divided reference signal with the divided receiver signal to generate a control signal that determines a frequency of the receiver signal in accordance with the receiver gain curve.

7. The method of claim 2, further comprising in the transmission mode:
generating a divided reference signal by frequency-division of the reference signal;
generating a divided transmitter signal by frequency-division of the transmitter signal; and
comparing the divided reference signal with the divided transmitter signal to generate a transmitter code sent to the transmitter oscillator for determining the transmitter gain curve.

8. The method of claim 7, further comprising in the transmission mode:
comparing the divided reference signal with the divided transmitter signal to generate a control signal that determines a frequency of the transmitter signal in accordance with the transmitter gain curve.

9. The method of claim 1, further comprising:
entering a stand-by mode for a current reception or transmission mode until a prior reception or transmission mode is terminated.

10. The method of claim 9, wherein the prior reception or transmission mode is terminated when a respective grain curve is determined for the prior reception or transmission mode.

11. An automatic frequency controller comprising:
a start controller for indicating one of a reception mode and a transmission mode;
a frequency detector for comparing a reference signal with a receiver signal in a reception mode, and for comparing the reference signal with a transmitter signal in a transmission mode; and
a data code block for determining a receiver code in the reception mode and for determining a transmitter code in the transmission mode, depending on the comparison from the frequency detector.

12. The automatic frequency controller of claim 1, wherein a receiver oscillator generates the receiver signal according to a receiver gain curve determined by the receiver code, and wherein a transmitter oscillator generates the transmitter signal according to a transmitter gain curve determined by the transmitter code.

13. The automatic frequency controller of claim 12, wherein the transmitter oscillator, the receiver oscillator, the start controller, the frequency detector, and the data code block are formed on one chip.

14. The automatic frequency controller of claim 12, wherein the start controller includes:
means for entering a stand-by mode for a current reception or transmission mode until a prior reception or transmission mode is terminated.

15. The automatic frequency controller of claim 14, wherein the prior reception or transmission mode is terminated when a respective gain curve is determined for the prior reception or transmission mode.

16. An integrated frequency synthesizer, comprising:
a receiver oscillator for generating a receiver signal having a frequency according too receiver gain curve;
a transmitter oscillator for generating a transmitter signal having a frequency according to a transmitter gain curve; and
an automatic frequency controller for generating a receiver code that determines the receiver gain curve by comparing a reference signal and the receiver signal in a reception mode, and for generating a transmitter code that determines the transmitter gain curve by comparing the reference signal and the transmitter signal in a transmission mode.

17. The integrated frequency synthesizer of claim 16, further comprising:
a reference oscillator for generating the reference signal.

18. The integrated frequency synthesizer of claim 16, wherein the transmitter oscillator, the receiver oscillator, and the automatic frequency controller are formed on one chip.

19. The integrated frequency synthesizer of claim 16, wherein the automatic frequency controller includes:
a start controller for indicating one of the reception mode and the transmission mode;
a frequency detector for comparing the reference signal with the receiver signal in the reception mode, and for comparing the reference signal with the transmitter signal in the transmission mode; and
a data code block for determining the receiver code in the reception mode and for determining the transmitter code in the transmission mode, depending on the comparison from the frequency detector.

20. The integrated frequency synthesizer of claim 16, wherein the automatic frequency controller further includes:
means for entering a stand-by mode for a current reception or transmission mode until a prior reception or transmission mode is terminated.

21. The integrated frequency synthesizer of claim 16, further comprising:
a first reference frequency divider for generating a first divided reference signal by frequency-division of the reference signal;
a receiver frequency divider for generating a divided receiver signal by frequency-division of the receiver signal;
a receiver phase-locked loop (PLL) for comparing the first divided reference signal with the divided receiver signal to generate a first control signal that determines a frequency of the receiver signal in accordance with the receiver gain curve;
a second reference frequency divider for generating a second divided reference signal by frequency-division of the reference signal;
a transmitter frequency divider for generating a divided transmitter signal by frequency-division of the transmitter signal; and
a transmitter phase-locked loop (PLL) for comparing the second divided reference signal with the divided transmitter signal to generate a second control signal that determines a frequency of the transmitter signal in accordance with the transmitter gain curve.
